(19) United States
(12) Patent Application Publication
(10) Pub. No.: US 2015/0380119 A1
(43) Pub. Date: Dec. 31, 2015

(54) METHOD AND APPARATUS FOR SYNTHESIZING RADIOACTIVE TECHNETIUM-99M-CONTAINING SUBSTANCE

(71) Applicant: Inter-University Research Institute Corporation High Energy Accelerator Research Organization, Tsukuba-shi (JP)

(72) Inventor: Kanetada NAGAMINE, Tsukuba-shi (JP)

(73) Assignee: Inter-University Research Institute Corporation High Energy Accelerator Research Organization, Tsukuba-shi (JP)

(21) Appl. No.: 14/752,544

(22) Filed: Jun. 26, 2015

Related U.S. Application Data
(63) Continuation of application No. PCT/JP2013/083161, filed on Dec. 11, 2013.
(60) Provisional application No. 61/746,839, filed on Dec. 28, 2012.

(30) Foreign Application Priority Data
Dec. 28, 2012 (JP) 2012-288140

(51) Int. Cl. G21G 1/10

(52) U.S. Cl. CPC G21G 1/10; G21G 2001/0042

(57) ABSTRACT

A method for synthesizing a radioactive technetium-99m-containing substance and a synthesizing device are provided. The method for synthesizing a radioactive technetium-99m-containing substance has a step for generating negative muons and a step for irradiating the negative muons onto a ruthenium sample. The ruthenium material preferably includes a metallic ruthenium and/or a ruthenium compound. Also, the ruthenium sample preferably has a plurality of superimposed ruthenium thin plates having a thickness of 4 mm or less.

### CROSS-REFERENCE TO RELATED APPLICATION

This application is a continuation of International Application PCT/JP2013/083161 which was filed on Dec. 11, 2013, and claims priority from Japanese Patent Application 2012-288140 which was filed on Dec. 28, 2012, and U.S. Provisional Patent Application 61/746,839 which was filed on Dec. 28, 2012, the contents of which are herein wholly incorporated by reference.

### TECHNICAL FIELD

The present invention relates to a method for synthesizing a radioactive technetium-99m-containing substance.

### BACKGROUND ART

A radioactive technetium-99m (^{99m}Tc: a nuclear isomer of technetium-99) has a half-life of 6.0 hours, and has a characteristic of generating easy-to-measure gamma rays of 140 keV but no beta rays. Because of this characteristic, the radioactive technetium-99m is used as a major radioactive element which supports one field called nuclear medicine in the medical science, and is used for scintigram of every part of the body, including the bones, the kidney, the lungs, the thyroid glands, and the liver. The ^{99m}Tc accounts for 80% of all the radioactive elements used for medical service, and the present domestic consumption of the ^{99m}Tc reaches 1 k 6-day-Ci/week (6-day-Ci means the number of curies six days after ^{99m}Tc is shipped from separation/refining facilities).

Until now, radioactive technetium-99m has been obtained by inserting highly enriched uranium 135 (¹³⁵U) in a dedicated. reactor to cause nuclear fission reactions, creating molybdenum-99 (⁹⁹Mo) having a half-life of 67 hours as a result of the nuclear fission reactions, and causing beta decay of ⁹⁹Mo (reactor method). Another method for obtaining the radioactive technetium-99m involves use of (p, 2n) reactions of highly enriched molybdenum-100 with a high-intensity low-energy proton accelerator. At present, most of the radioactive technetium-99m products used for medical service are synthesized by the reactor method. Moreover, our country depends on imports from foreign reactor facilities for all the radioactive technetium-99m products used in our country.

### CITATION LIST

### Patent Literature

Patent Literature 1: Japanese Patent Laid-Open No. 2011-153827

Patent Literature 2: Japanese Patent Laid-Open No. 2010-127825

Patent Literature 3: Japanese Patent Laid-Open No. 2001-85200

Patent Literature 4: Japanese Patent Laid-Open No. 10-106800

Patent Literature 5: Japanese Patent Laid-Open No. 2011-105567

Patent Literature 6: Japanese Patent Laid-Open No. 2011-2370

Patent Literature 7: Japanese Patent Laid-Open No. 2008-31048

Patent Literature 8: Japanese Patent No. 2857349

### Non Patent Literature

Non Patent Literature 1: J. M. Cuttler and 31st Ann. Conf. Canadian Nucl. Soc. (2010).

Non Patent Literature 2: B. Scholten et al., Appl. Radia. Isotopes, 51 (1999) 69.

Non Patent Literature 3: K. Nagamine, “Introductory Muon Science”, Cambridge Univ. Press (2003) 1-208.

Non Patent Literature 4: H. Miyadera et al., Nucl. Instr. 569 (2006) 713.

Non Patent Literature 5: T. Suzuki et al., Phys. Rev. C35 (1987) 2212.

Non Patent Literature 6: The Table of Isotopes (8th edition) eds. R. B. Firestone et al. John Wiley (1996).

Non Patent Literature 7: D. F. Measday, Phys. Report 354 (2001) 243.

Non Patent Literature 8: M. Lifshitz et al., Phys. Rev. C22 (1980) 2135.

### SUMMARY OF INVENTION

### Technical Problem

In recent years, the reactors of the foreign countries, which have been supplying parent molybdenum-99 of the radioactive technetium-99m, are getting older, and their deactivation and decommission time is getting closer, and therefore a highly efficient alternative method for producing radioactive technetium-99m is being searched.

An object of the present invention is to provide a method for synthesizing a radioactive technetium-99m-containing substance.

### Solution to Problem

In order to accomplish the above object, a disclosed method for synthesizing a technetium-99m-containing substance adopts following means.

A first aspect relates to a method for synthesizing a radioactive technetium-99m-containing substance, including the steps of: generating negative muons; and irradiating a ruthenium sample with the negative muons.

A second aspect further relates to the method for synthesizing a radioactive technetium-99m-containing substance, wherein the ruthenium sample contains at least one of metal ruthenium and ruthenium compounds.

A third aspect further relates to the method for synthesizing a radioactive technetium-99m-containing substance, wherein the ruthenium sample is a laminate of a plurality of ruthenium thin plates having a thickness of 4 mm or less.

### Advantageous Effects of Invention

According to the present invention, a method for synthesizing a radioactive technetium-99m-containing substance can be provided.

### BRIEF DESCRIPTION OF DRAWINGS

FIG. 1 illustrates a configuration example of a technetium-99m-containing substance synthesizing apparatus in this embodiment.

FIG. 2 illustrates an example of a cross section of a muon synthesizing beam optical system unit.

FIG. 3 illustrates a dependence of differential cross section on momentum of pion in positive pion generation caused by reaction between 500-MeV protons and carbon (experimental values).

FIG. 4 illustrates generation of muons by pion decay. FIG. 5 illustrates a dependence of maximum momentum and minimum momentum of muons generated from flying pions on pion momentum.

FIG. 6 illustrates decay angles in the case where pions with various momentums decay, representing the spread of angles with respect to muons having minimum to maximum momentums.

FIG. 7 illustrates a calculation example of an expected amount of negative muon generation.

FIG. 8 illustrates reactions of absorption of negative muons into a ruthenium nucleus (1).

FIG. 9 illustrates reactions of absorption of negative muons into a ruthenium nucleus (2).

FIG. 10 illustrates experimental values or theoretical values representing ratios in nuclear absorption reaction between ¹⁰⁷Ag which is close to ruthenium in atomic number and muons.

FIG. 11 illustrates a dependence of the range of muons in various substances on muon momentum.

FIG. 12 illustrates a dependence of absorption coefficients of light in various substances on light energy.

FIG. 13 illustrates the amount and characteristics of radioactive technetium-99m synthesized by a reactor, a low-energy proton accelerator, and an intermediate-energy proton accelerator.

FIG. 14 illustrates a momentum width in the range of ±5% in a muon synthesizing beam optical system unit 116 confirmed by simulation calculation.

FIG. 15 illustrates solid angles in the muon synthesizing beam optical system unit 116 confirmed by simulation calculation.

FIG. 16 illustrates an example of an irradiated sample analyzing system.

### DESCRIPTION OF EMBODIMENTS

Hereinbelow, an embodiment will be described with reference to the accompanying drawings. The configuration of the embodiment is illustrative, and the invention is not limited to the configuration of the disclosed embodiment.

### EXAMPLE

(Muon)

A muon is a kind of elementary particle. The muon is classified into two particles having positive and negative charges, respectively. The positive muon having a positive charge and the negative muon having a negative charge have a life of 2.2 μs in the vacuum. The muons have a mass 1/9 the mass of protons, and 207 times larger than electrons. The muons come flying to the surface of the earth as cosmic rays, and are also created in large amounts by using a particle accelerator which can generate protons having the energy of 150 MeV or more, and the like.

Since the muons captured in a substance mainly have electromagnetic interaction with surrounding atoms, the behavior of the muons in the substance can be understood with the positive muon being considered as a light proton and the negative muon as a heavy electron.

When negative muons (heavy electrons) having the energy of about 1 MeV or more are injected into a substance and are stopped therein, the following phenomenon occurs.

(1) A negative muon passes through surrounding electrons, approaches an atomic nucleus, and forms a small atom (muonic atom) in a highly-excited state around the atomic nucleus.

(2) Through transition in the muonic atom, the negative muon reaches a ground state in one nanosecond or less. The muonic atom with atomic number Z has a ground state radius of 270/Z×10⁻¹³ cm. In the case of ¹⁰⁰Ru (Z=44), the radius is 6.14×10⁻¹³ cm.

(3) The nucleus with mass number A has a radius of 1.2 ×A^{1/3}×10⁻¹³ cm, and the nucleus of ¹⁰⁰Ru (Z=44) has a radius of 5.57×10⁻¹³ cm. Since the ground state radius of the muonic atom is comparable to the radius of the nucleus, a weak interaction in a close distance becomes effective between the nucleon and the negative muon, which induces a nuclear absorption reaction of an elementary process (μ⁻+p→n+νμ), and this nuclear absorption reaction competes with free decay of the negative muon (μ⁻→e⁻+νμ+νₑ). In the case of (Z=44), 95% of negative muons are absorbed in the nucleus, and 5% freely decay, based on the property of the weak interaction and the orbital wave function of the nucleus and the muon.

(4) Following the nuclear absorption reaction of the muon, a wide range of particles such as neutrons and protons are emitted from the nucleus in the excited state, and various nuclear isotopes are generated accordingly. Since a negative charge is added by the negative muon, unique nuclear transmutation and element transformation reaction are achieved.

Here, among radioactive substances generated by the nuclear reaction between the negative muon and ruthenium, most of the substances have a short life and attenuate in short time, or have a long life. Hereinafter, the negative muon is also referred to as a muon.

(Technetium-99m-Containing Substance Synthesizing Apparatus)

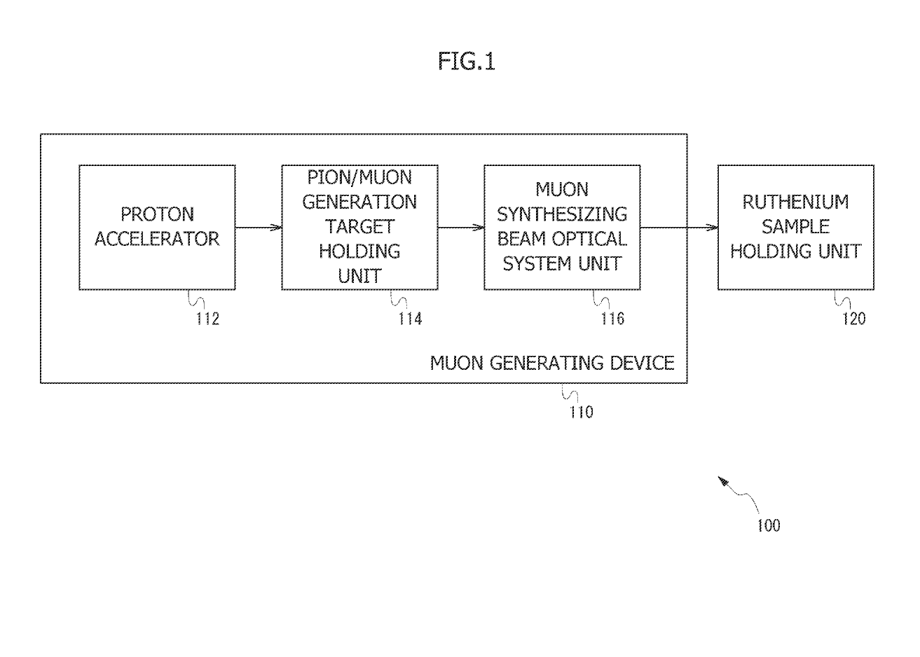

FIG. 1 illustrates a configuration example of a technetium-99m-containing substance synthesizing apparatus in the present embodiment. The technetium-99m-containing substance synthesizing apparatus 100 includes a muon generating device 110 and a ruthenium sample holding unit 120. The muon generating device 110 includes a proton accelerator 112, a pion/muon synthesis target holding unit 114, and a muon synthesizing beam optical system unit 116.

The proton accelerator 112 accelerates protons to synthesize a proton beam focused on a specified position.

The pion/muon synthesis target holding unit 114 holds a pion/muon synthesis target at the focus position of the proton beam accelerated with the proton accelerator 112. As the pion/muon synthesis target, a cylindrical graphite material having a diameter of 5 cm and a length of 15 cm is used, for example. The pion/muon synthesis target is placed in a vacuum space communicating with a pipe of the proton beam.

The muon synthesizing beam optical system unit 116 confines, transports, and outputs pions which are generated when the pion/muon synthesis target is irradiated with a proton beam. Since some of the pions are converted into muons during confinement transport, the muon synthesizing beam optical system unit 116 can output a muon beam. Two muon synthesizing beam optical system units 116 may be arranged symmetrically with respect to the proton beam, around the pion/muon synthesis target.

The ruthenium sample holding unit 120 holds the ruthenium sample at the focus position of the muon beam which is collected by the muon synthesizing beam optical system unit 116.

For example, the ruthenium sample is one of (1) metal ruthenium, (2) ruthenium oxide, (3) ruthenium nitrate, (4) ruthenium sulfate, (5) other ruthenium compounds, or mixtures of these. The ruthenium sample is not limited thereto. For example, the ruthenium sample may contain at least one of metal ruthenium and ruthenium compounds. The ruthenium sample contains at least ruthenium.

For example, the ruthenium sample is a laminate of a plurality of ruthenium thin plates. The ruthenium thin plate has a thickness of 0.4 cm or less.

The ruthenium contained in the ruthenium sample may be natural ruthenium, or ruthenium with one specific mass number, or may contain ruthenium with a plurality of specific mass numbers. For example, the ruthenium contained in the ruthenium sample may be constituted of ruthenium with mass number 100 and ruthenium with other mass numbers, the former ruthenium being larger in amount than the latter ruthenium. By using the ruthenium sample containing a large amount of the ruthenium with mass number 100, a technetium-99m-containing substance which contains a large amount of technetium-99m can be synthesized.

(Proton Accelerator)

Examples of the proton accelerator 112 include a medium-size superconducting proton cyclotron having energy of 500 MeV, current of 300 μA, and a magnetic field of 8 T. When the medium-size superconducting proton cyclotron is used as the proton accelerator 112, 2.2×10¹¹ muons per second are obtained.

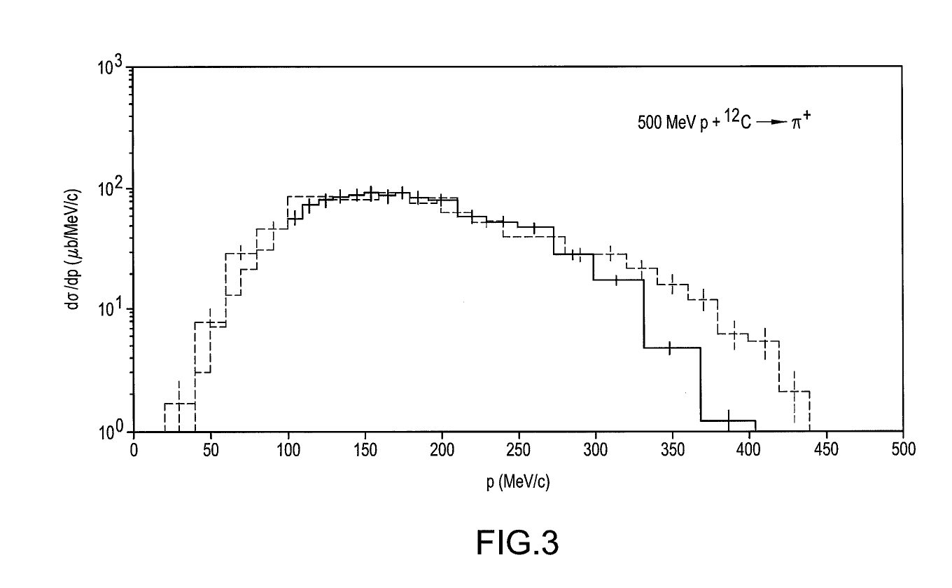

The technetium-99m can be synthesized within a Ru sample of an appropriate size by keeping muons in a range of cm-thickness. Accordingly, pions having momentum of 150 MeV/c are captured into the muon synthesizing beam optical system unit 116 to transform the pions into muons. As illustrated in FIG. 3, protons of about 500 MeV are appropriate for efficient synthesis of 150-MeV/c pions.

Moreover, a proton accelerator for cancer treatment with energy of 250 MeV and current of 0.8 μA may be used as the proton accelerator 112 for theory verification, for example.

The proton accelerator with the energy sufficiently higher than 140 MeV, that is the mass of the pions, may be used as the proton accelerator 112.

(Muon Synthesizing Beam Optical System Unit)

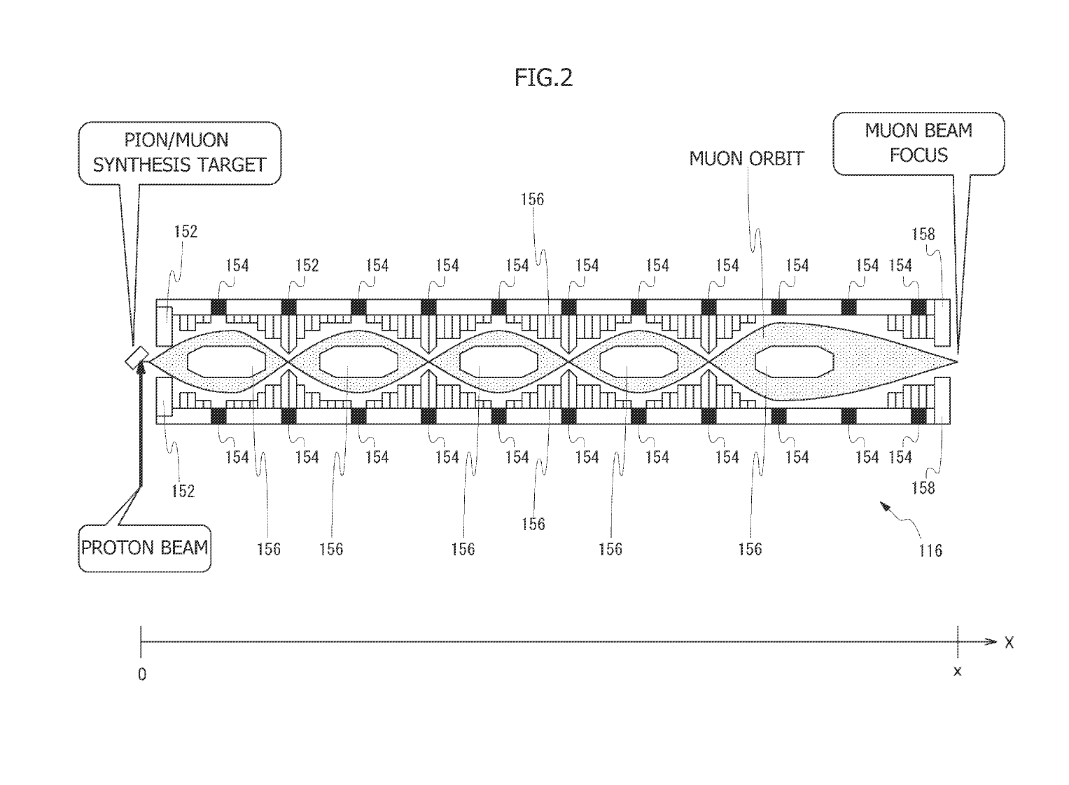

FIG. 2 illustrates an example of a cross section of the muon synthesizing beam optical system unit. The muon synthesizing beam optical system unit 116 includes a normal conducting magnet coil 152, a plurality of superconducting magnet coils 154, radiation shields 156, and a magnetic shield 158.

The muon synthesizing beam optical system unit 116 has an overall length (a length in a beam travel axis direction) of 6 m, for example. Although the life of a stopped pion is 26 ns, the life is extended by a relativistic effect caused by movement of the pion. The relationship between a decay length L (cm) and momentum P <MeV/c> of the pion is expressed as L=5.593 P. The decay length of the pion is a length with which the intensity of the pion is equal to 1/e. Therefore, the decay length of the 150-MeV/c pion is 8.4 m. Moreover, 51% of the 150-MeV/c pions transform into muons during 6-m flight, and 71% transform into muons during 10-m flight.

In the muon synthesizing beam optical system unit 116, diffusing behavior of the beam in a direction perpendicular to a beam travel axis (cross direction in FIG. 2) is changed into rotary motions around the axis by the action of magnetic fields applied in the beam travel axis direction. As a result, large solid angle capture and confinement transport of pions/muons are achieved. In order to capture and confine 150-MeV/c pions at an angle of 22 degrees and in a radius of 20 cm, a maximum of one-tesla magnetic fields may be provided in the beam travel axis direction. A plurality of circular coils are used to generate the magnetic fields in the beam travel axis direction and to make the generated magnetic fields converge a plurality of times, which makes it possible to downsize the coils as compared with the case of using one coil. The beam travel axis direction extends from the pion/muon target to the ruthenium sample.

The normal conducting magnet coil 152 is closest to the pion/muon synthesis target held by the pion/muon synthesis target holding unit 114. The normal conducting magnet coil 152 is a circular coil. With use of the normal conducting magnet coil 152, the magnetic fields by the circular coils are generated in the beam travel axis direction. The normal conducting magnet coil 152 is arranged at the entrance of the muon synthesizing beam optical system unit 116. For example, the normal conducting magnet coil 152 has a radius of 20 cm and is arranged to have an angle of 22 degrees with respect to the pion/muon target. The normal conducting magnet coil 152 may be replaced with a superconductive coil.

The superconducting magnet coil 154 converges pions/muons captured into the muon synthesizing beam optical system unit 116. The superconducting magnet coil 154 with a diameter of 1 m generates a maximum of one-tesla magnetic fields in the beam travel axis direction. In the example of FIG. 2, the muon synthesizing beam optical system unit 116 includes eleven superconducting magnet coils 154. With use of the superconducting magnet coils 154, the magnetic fields by the circular coils are in the beam travel axis direction are generated. The superconducting magnet coil 154 may be replaced with a normal conducting coil.

The radiation shields 156 are arranged inside and outside a muon orbit. That is, the muons pass through between the inner radiation shields 156 and the outer radiation shields 156. For example, the radiation shields inside the muon orbit are hung by stainless lines extending from the outside of the muon orbit.

The magnetic shields 158 are arranged to prevent the magnetic fields from the superconducting magnet coil 154 from leaking out of the system.

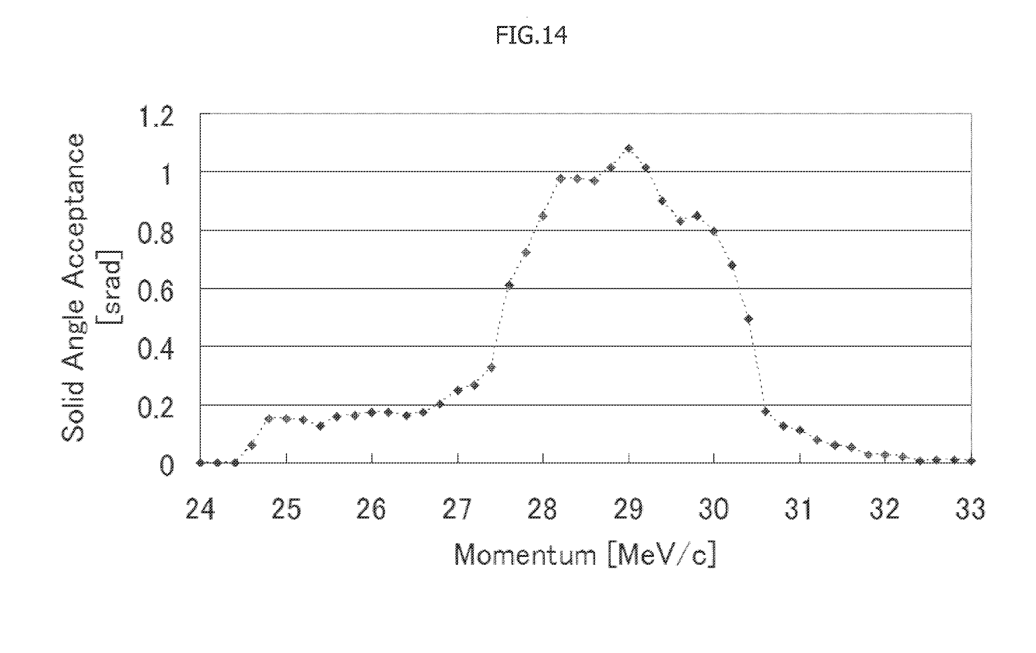

FIG. 14 illustrates a momentum width in the range of ±5% in the muon synthesizing beam optical system unit 116 confirmed by simulation calculation. In FIG. 14, an ordinate represents solid angle acceptance, which is obtained based on simulation calculation, with respect to pions/muons with various momentums.

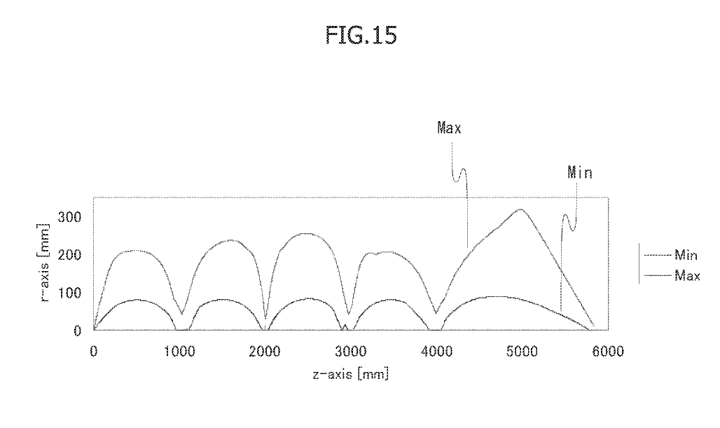

FIG. 15 illustrates solid angles in the muon synthesizing beam optical system unit 116 confirmed by simulation calculation. In FIG. 15, a lower (upper) curve represents an orbit of the pions/muons captured at a minimum (maximum) solid angle.

When the pion/muon synthesis target is irradiated with a proton beam synthesized with the proton accelerator 112, pions are generated. The muon synthesizing beam optical system unit 116 captures the pions synthesized by the pion/muon synthesis target from the side of the normal conducting magnet coil 152 (left-hand side of FIG. 2). The captured pions are confined and transported by the normal conducting magnet coil 152 and the superconducting magnet coil 154. During confinement transport, some of the pions transform into muons and go out (right-hand side in FIG. 2). The ruthenium sample is arranged at the focus position of the muon beam. The ruthenium sample is held by the ruthenium sample holding unit 120. The nuclear reaction between ruthenium and muons is induced by irradiation of the ruthenium sample with the muon beam.

FIG. 3 illustrates a dependence of differential cross section on momentum of pion in positive pion generation caused by reaction between 500-MeV protons and carbon (experimental values). The solid angle of measurement is 0.5 steradian. In FIG. 3, an abscissa of the graph represents momentum and an ordinate represents a differential cross section.

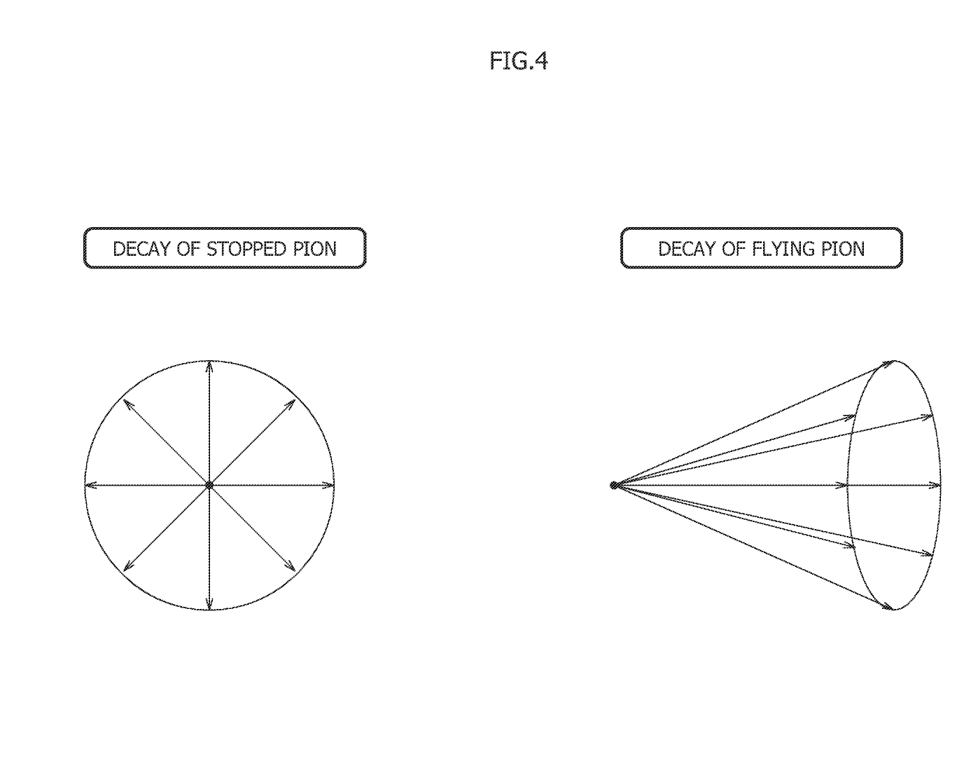

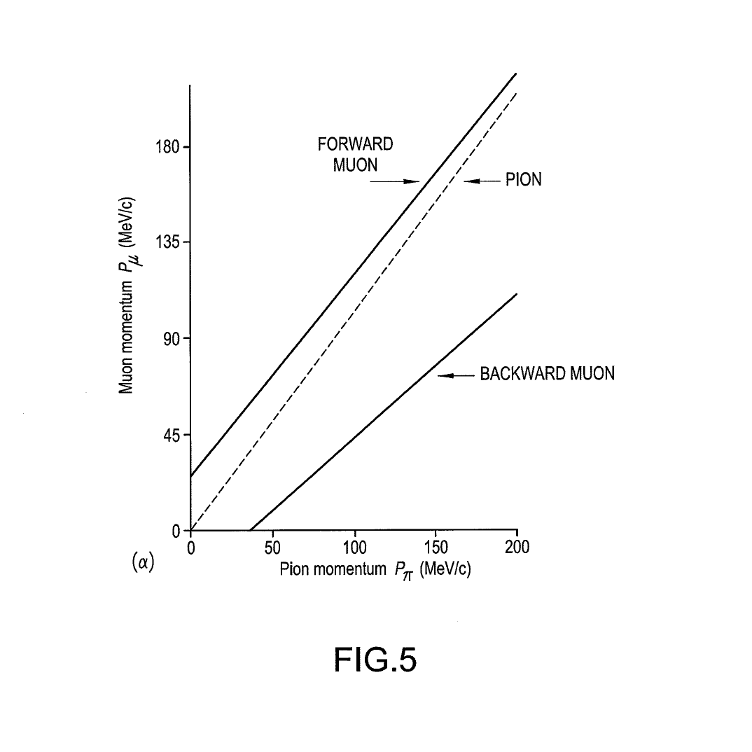

FIG. 4 illustrates generation of muons by pion decay. FIG. 4 depicts a vector representing isotropic generation of muons from a stopped pion, and a vector representing anisotropic generation of muons from flying pions.

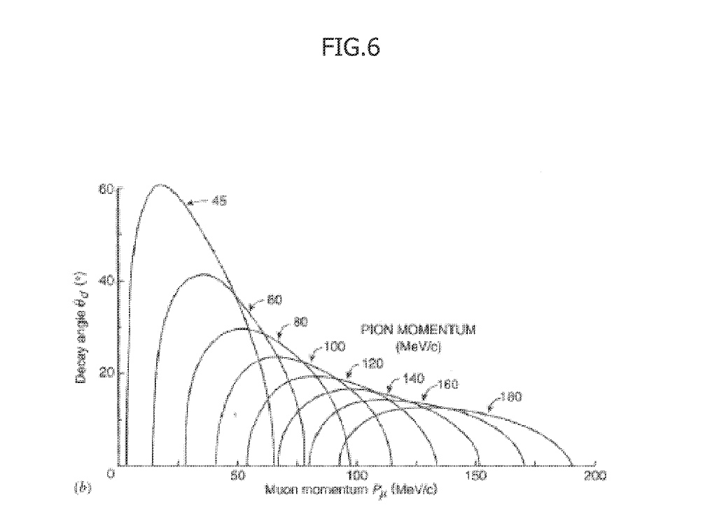

FIG. 5 illustrates a dependence of maximum momentum and minimum momentum of muons generated from flying pions on pion momentum. In FIG. 5, an abscissa of the graph represents the momentum of pions, and an ordinate represents the momentum of muons. FIG. 6 illustrates decay angles in the case where pions with various momentums decay, representing the spread of angles with respect to muons having minimum to maximum momentums. In FIG. 6, an abscissa of the graph represents the momentum of muons, and an ordinate represents decay angles.

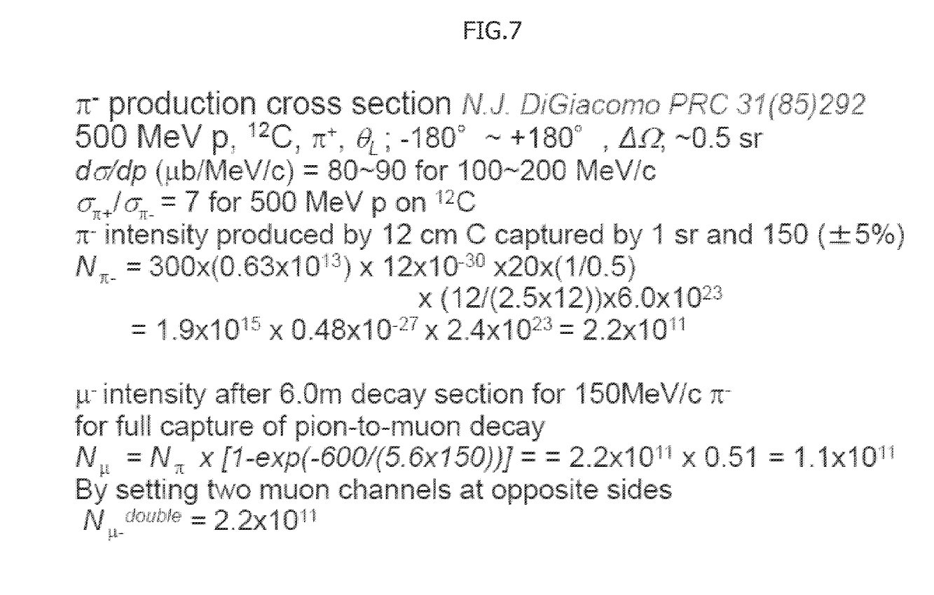

FIG. 7 illustrates a calculation example of an expected amount of negative muon generation.

The intensity of protons with a current of 300 μA is 1.9×10¹⁵ (=J) per second on the basis of elementary charge being defined as 1.60×10⁻¹⁹ coulomb. The dependence of a differential cross section on momentum with respect to a solid angle of 0.5 steradian, where positive pions with the momentum of 150 MeV/c are generated by collision of protons having 500-MeV energy with a carbon target, is as illustrated in FIG. 3. A ratio in cross section between negative pions and positive pions is 1/7. The cross section where negative pions of 150 MeV/c (65 MeV) are generated in the momentum range of ±5%, is 0.48×1⁻²⁷ cm² (=σ) when it is assumed that the negative pions are captured at a solid angle of 1 steradian and in the momentum range of ±5%. The number of atoms of carbon with a thickness of 12 cm is 2.4×10²³ cm⁻² (=nt). Based on the product of these three values (J σ nt), the intensity of the pions captured by the muon synthesizing beam optical system unit is 2.2×10¹¹ per second.

Since 51% of the pions change into muons while the pions fly for 6.0 m, the intensity of the negative muons at the exit of the muon synthesizing beam optical system unit is 1.1×10¹¹ per second. As a result of pion-muon conversion, the momentum (energy) possessed by the muons becomes 70 MeV/c (21 MeV)-155 MeV/c (82 MeV) as illustrated in FIG. 6. In this case, as illustrated in FIG. 6, the decay angle falls within 20 degrees, and therefore all the pions are captured into the muon synthesizing beam optical system unit. The ratio of conversion from pions to muons can be obtained based on relativistic correction of 26 ns that is the life of a stopped pion. For example, when two muon synthesizing beam optical system units are arranged at right angle to the direction of the proton beam, the intensity of negative muons becomes 2.2×10¹¹ per second. In this case, the muon synthesizing beam optical system units are arranged in mirror symmetry.

(Absorption Reaction of Negative Muons into Ruthenium Nucleus)

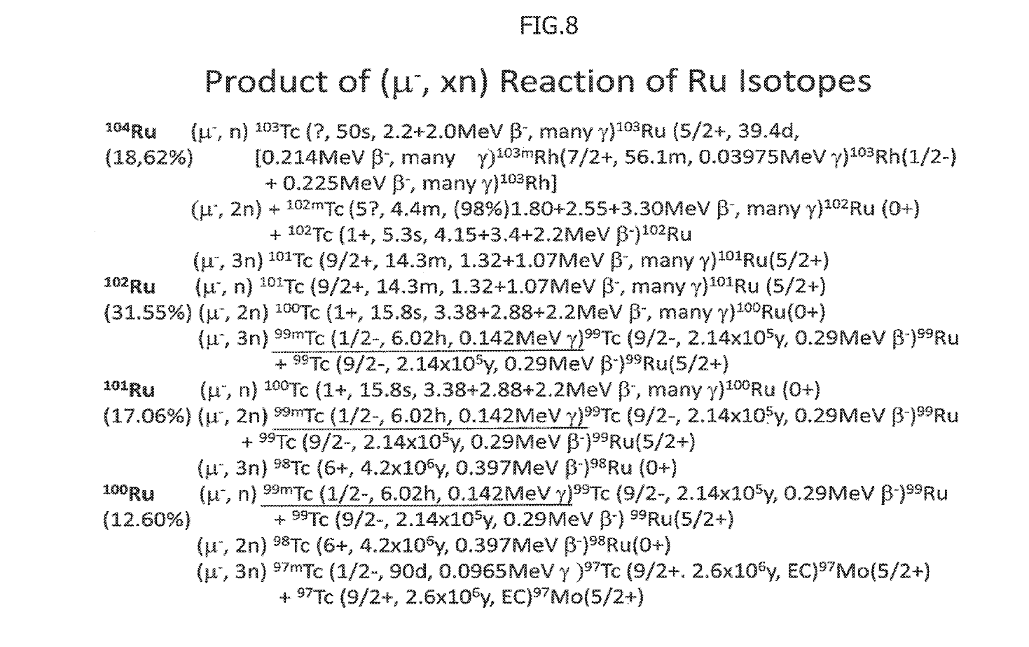

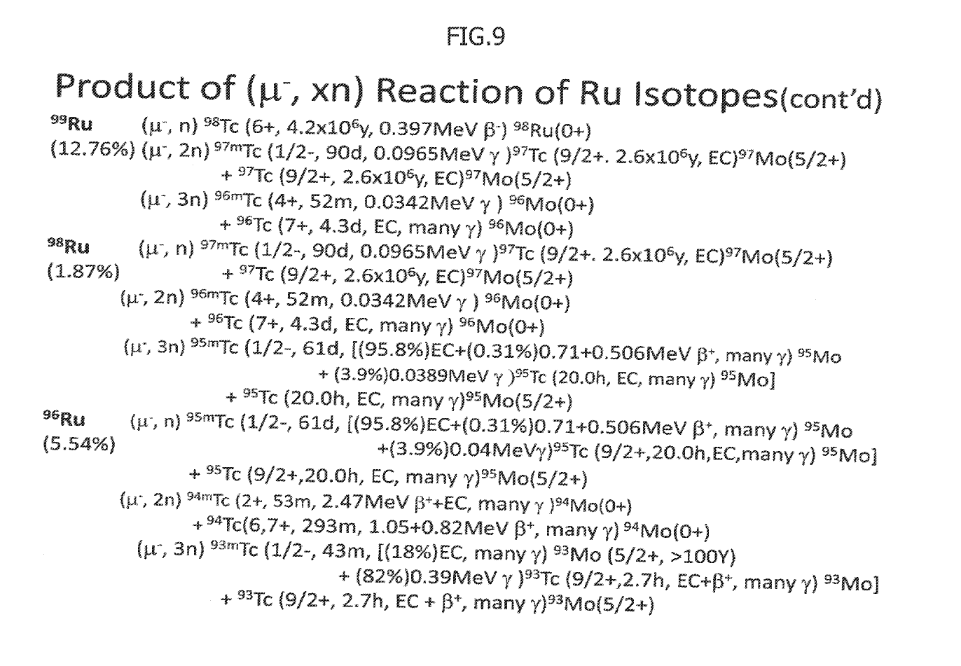

FIGS. 8 and 9 illustrate reactions of absorption of negative muons into a ruthenium nucleus. FIGS. 8 and 9 illustrate absorption reactions of negative muons into ruthenium 96, ruthenium 98, ruthenium 99, ruthenium 100, ruthenium 102, and ruthenium 104. The ruthenium 96, the ruthenium 98, the ruthenium 99, the ruthenium 100, the ruthenium 102, and the ruthenium 104 are provided by nature.

All the negative muons incident on the ruthenium sample and stopped inside the ruthenium sample create muonic atoms around the nuclei in a substance. In the case of ruthenium, 95% or more negative muons are absorbed into the nucleus due to the weak interaction between the muons and the nuclei, and the nuclear reaction illustrated in FIGS. 8 and 9 is induced.

Among the main radioactive elements generated by the nuclear reaction between ruthenium and the negative muons in FIGS. 8 and 9, only ^{99m}Tc is the radioactive element whose main half-life is about six hours. Other radioactive elements include radioactive elements having a half-life much shorter than six hours, radioactive elements having a half-life much longer than six hours, or radioactive elements whose rate of synthesis is small.

It is known that the nuclear absorption reactions of negative muons include not only the neutron generating reaction but also the reactions of generating protons and alpha particles.

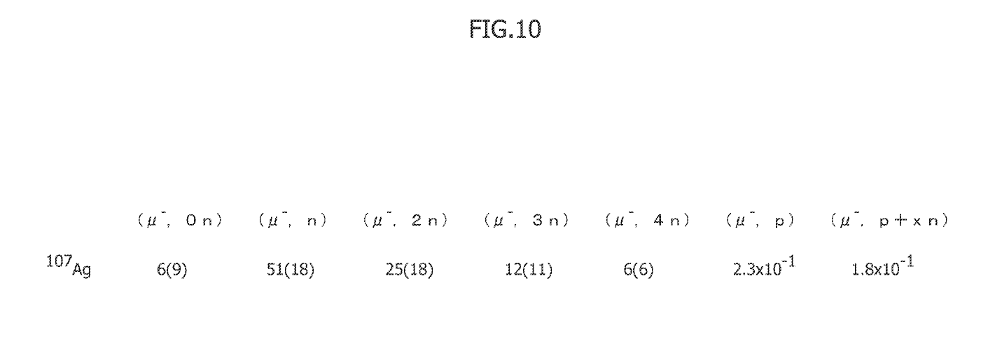

FIG. 10 illustrates experimental values or theoretical values representing the ratios in nuclear absorption reaction of muons by ¹⁰⁷Ag which is close to ruthenium in atomic number. For example, in the experimental values or theoretical values of FIG. 10, one neutron is emitted at the ratio of 51%, two neutrons are emitted at the ratio of 25%, and one proton is emitted at the ratio of 0.23% in the nuclear absorption reactions of muons by ¹⁰⁷Ag. In FIG. 10, the ratio of neutron emission is an experimental value and the ratio of proton emission is a theoretical value. Here, in the nuclear absorption reactions of muons by g the values larger in proton emission ratio, including one neutron (51%), two neutrons (25%), and three neutrons (12%), are chosen to be effective. If the nuclear absorption reaction between ruthenium and muons is considered to be compatible with the nuclear absorption reaction between ¹⁰⁷Ag and muons, the nuclear absorption reaction of muons by ruthenium results in emission of one neutron (51%), two neutrons (25%), and three neutrons (12%). For example, in the nuclear absorption reaction of negative muons by the ruthenium 100, radioactive technetium-99m is generated at the ratio of 51%.

When a ruthenium sample containing natural ruthenium is irradiated with 2.2×10¹¹ muons per second, radioactive technetium-99m is synthesized at the rate of 3.3×10¹⁰ per second as expressed by the following expression. Here, an abundance ratio of ¹⁰²Ru, ¹⁰¹Ru, and ¹⁰⁰Ru in natural ruthenium is 0.32, 0.17, and 0.13, respectively.

$$[ Expression 1 ]$$

$$\begin{matrix}{N}_{Tc 99 m} = {N}_{μ -} \times [ {}^{102} Ru ( {μ}^{-} , 3 n ) + {}^{101} Ru ( {μ}^{-} , 2 n ) + {}^{100} Ru ( {μ}^{-} , n ) ] \\ = 2.2 \times {10}^{11} \times [ 0.32 \times 0.12 + 0.17 \times 0.25 + 0.13 \times 0.51 ] \\ = 3.3 \times {10}^{10}\end{matrix}$$

In this case, a secular equilibrium value of radioactive technetium-99m (the number of atoms when synthesis and decay progress at the same time) is 1.0×10¹⁵(=3.3×10¹⁰/3.19×10⁻⁵).

When the ruthenium sample containing natural ruthenium is irradiated with 2.2×10¹¹ muons per second for 12 hours, radioactive technetium-99m having an accumulated radiation intensity of 2.5×10¹⁰ Bq/12 h is obtained. Furthermore, by repeating this irradiation twelve times, radioactive technetium-99m having a total radiation intensity of 3.0×10¹¹ Bq is obtained in six days.

When a ruthenium sample containing only ruthenium 100 as ruthenium (hereinafter referred to as ruthenium 100 sample) is irradiated with 2.2×10¹¹ muons per second, radioactive technetium-99m is synthesized at the rate of 1.1×10¹¹ per second as expressed by the following expression:

$$\begin{matrix}{N}_{Tc 99 m} = {N}_{μ -} \times [ {}^{100} Ru ( {μ}^{-} , n ) ] \\ = 2.2 \times {10}^{11} \times [ 0.51 ] \\ = 1.1 \times {10}^{11}\end{matrix} \qquad [ Expression 2 ]$$

In this case, the radioactive technetium-99m has a secular equilibrium value of 3.4×10¹⁵(=1.1×10¹¹/3.19×10⁻⁵)

When the ruthenium 100 sample is irradiated with 2.2×10¹¹ muons per second for 12 hours, radioactive technetium-99m having an accumulated radiation intensity of 8.5×10¹⁰ Bq/12 h is obtained. By further repeating this irradiation twelve times, radioactive technetium-99m having a total radiation intensity of 1.0×10¹² Bq is obtained in six days.

When nuclear transmutation of the ruthenium contained in the ruthenium sample to radioactive technetium-99m is induced by the nuclear absorption reaction of negative muons, a radioactive technetium-99m-containing substance is obtained.

For further increase in the production amount in the future, such improvements as described below may be considered: (1) increase in the intensity of the proton accelerator (300 μA (0.15 MW)→3 mA (1.5 MW), 10 times); (2) increase in momentum acceptance by improvement of the muon synthesizing beam optical system unit (1.5 times); and (3) increase in the length of the muon synthesizing beam optical system unit (6 m→10 m, 1.4 times). By implementing these increase, radioactive technetium-99m having a radiation intensity of 1.8×10¹² Bq/12 h is obtained with use of the ruthenium 100 sample.

When the energy of the muons applied to the ruthenium sample is high, the muons pass through the ruthenium. On the contrary, when the energy of the muons applied to the ruthenium sample is low, the muons do not reach the vicinity of the nucleus of ruthenium. Therefore, when the energy of the muons applied to the ruthenium sample is too high or too low, the synthesis efficiency of the radioactive technetium-99m is lowered.

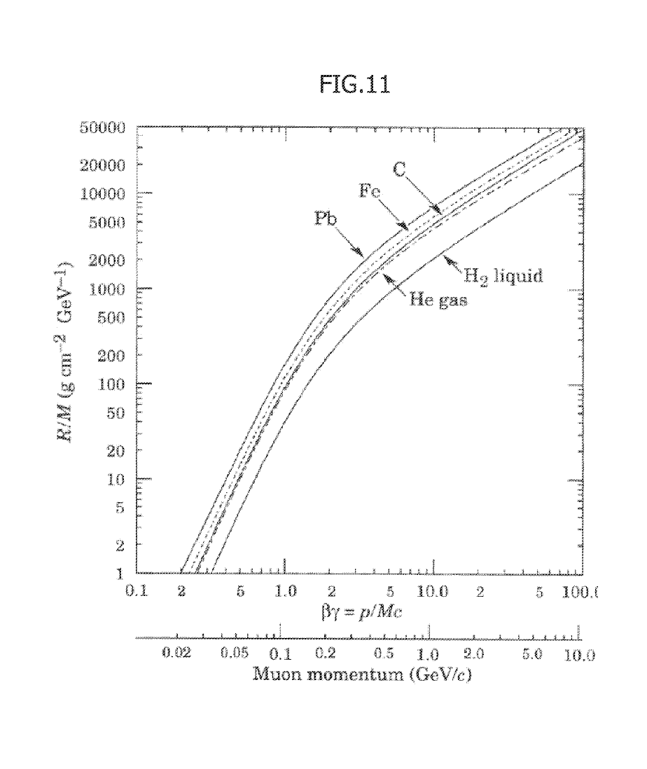

FIG. 11 illustrates a dependence of the range of muons in various substances on muon momentum. Here, an abscissa of FIG. 11 is momentum (energy) and an ordinate is the amount corresponding to the range, which is obtained by multiplying density by the thickness.

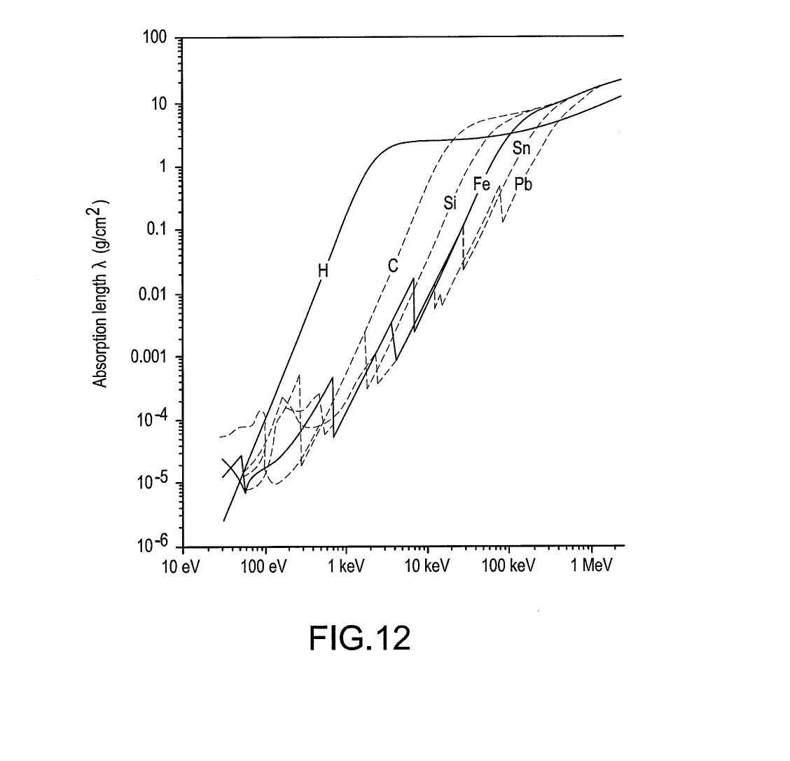

FIG. 12 illustrates a dependence of absorption coefficients of light in various substances on light energy. An abscissa of FIG. 12 represents energy, and an ordinate represents an absorption length.

In the graphs of FIGS. 11 and 12, ruthenium (Ru) is assumed to take a value between values of iron (Fe) and tin (Sn).

When the pion momentum acceptance of a channel is set to 150 MeV/c±5%, muons with a momentum (energy) of 70 MeV/c (21 MeV) to 155 MeV/c (82 MeV) are transported, and the ruthenium sample is irradiated with the muons. In order to stop all the muons (muons with a momentum (energy) of 70 MeV/c (21 MeV) to 155 MeV/c (82 MeV)) within the ruthenium sample, the thickness of the ruthenium sample is preferably 2.8 cm or more, since the thickness is found in the range of 0.4 cm to 2.8 cm based on the range of muons in FIG. 11. Here, the thickness of the ruthenium sample is the thickness in the beam travel axis.

Meanwhile, synthesis of technetium-99m is confirmed by detection of gamma rays of 140 keV. The 140-keV gamma rays are radiations emitted when technetium-99m decays. According to the graph of FIG. 12, if a middle point between Fe and Sn is assumed to be the value of ruthenium, the absorption length is 4 g/cm² at the value of 140 keV. Consequently, the 140-keV gamma rays generated at the time of decay of technetium-99m can be detected when the ruthenium sample has a thickness of 0.4 cm or less based on the density of ruthenium being 12.45 g/cm³. Therefore, for example, fourteen ruthenium samples with a thickness of 2 mm (=0.2 cm) are laminated to be used as a target.

The thickness of one laminate ruthenium sample (ruthenium thin plate) is preferably equal to or smaller than the thickness (0.40 cm) that enables 140-keV gamma rays to be measured. Moreover, to keep all the applied muons in the ruthenium sample, the thickness of the ruthenium sample is preferably 2.8 cm or more. Therefore, based on the energy of the muons to be applied, a plurality of ruthenium thin plates with a thickness of 0.4 cm or less are superimposed to form a laminate of the multiple thin plants with a thickness of 2.8 cm or more as a ruthenium sample. Since the muon beam converges into a diameter of about 5 cm, the ruthenium sample is sized to have a diameter of about 5 cm and a thickness of about 2.8 cm.

(Irradiated Sample Analyzing System)

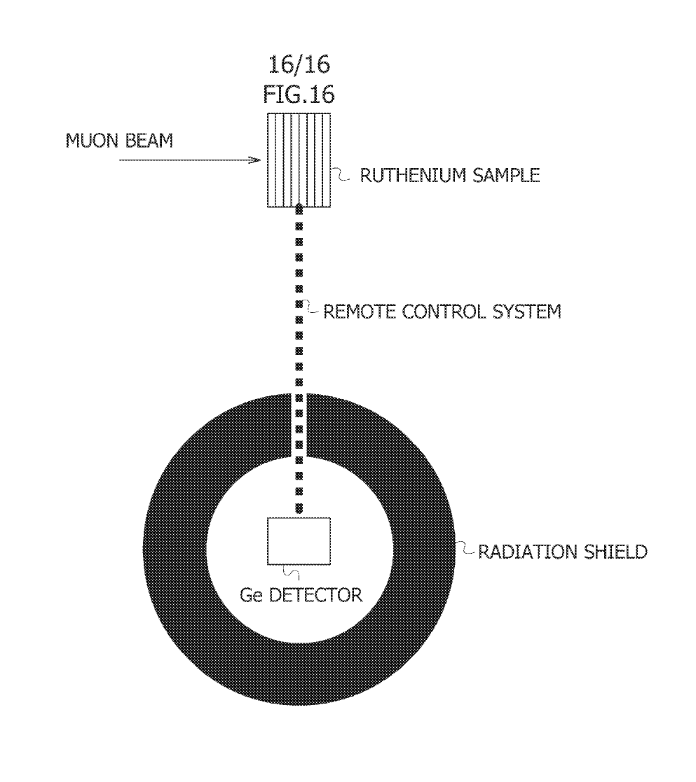

FIG. 16 illustrates an example of an irradiated sample analyzing system.

For monitoring the synthesizing state of the technetium-99m by muon irradiation, an irradiated sample analyzing system is prepared, which is connected with the technetium-99m-containing substance synthesizing apparatus 100. The irradiated sample analyzing system includes a radiation shield, a remote control system, and a Ge detector. The radiation shield covers the Ge detector and shields the radiations from the outside. A terminal unit of the remote control system extracts one ruthenium thin plate from the ruthenium sample irradiated with the muons, and transports it to the Ge detector inside the radiation shield. The Ge detector measures 140-keV gamma rays generated from the ruthenium sample irradiated with the muons.

(Yield of Technetium-99m)

Generally, when radioactivity is continuously created by muon irradiation and the like, the amount of created radioactivity becomes equal to the amount of disintegrated radioactivity as the passage of the time which is several times longer than the half-life of synthesized radioactive nuclei.

R₀=λR₁ [Expression 3]

Here, in consideration of synthesis of technetium-99m through nuclear absorption of muons by ruthenium nuclei, R₀ is synthesizing frequency of Tc99m by nuclear absorption of muons (decay frequency of Tc99m after a long time), λ is a decay constant of a Tc99m nucleus (=3.19×10⁻⁵/s=ln2/half-life), and N₁ is the number of nuclei of Tc99m after a long time.

$$Content of Tc 99 m = \frac{{R}_{0}}{λ {N}_{0}} [ g ] \qquad [ Expression 4 ]$$

Here, N₀ is the number of nuclei of Tc per 1 g (=6.02×10²³/98.9=6.09×10²¹).

When R₀ is 1.1×10¹¹/s, the content of Tc99m is 0.55 μg.

Here, to make Tc99m from the ruthenium sample with a diameter of 5 cm and a thickness of 2.8 cm, the yield of Tc99m (ratio between the content of Tc99m and the mass of the sample) is as follows:

$$\frac{0.55 µg}{3.14 \times {( 5 / 2 )}^{2} \times 2.8 \times 12.45 g} = \frac{0.55 \times {10}^{- 6}}{680} = 8.1 \times {10}^{- 10} \qquad [ Expression 5 ]$$

(Medical Radioactive Technetium-99m)

For example, ruthenium trioxide may be used as a ruthenium sample. When trioxide ruthenium is irradiated with muons, a mixture of trioxide ruthenium and trioxide technetium is synthesized. In the trioxide technetium, trioxide technetium containing radioactive technetium-99m is present. Since all the trioxide ruthenium in the mixture is stable, radioactive substances contained in the mixture include trioxide technetium containing radioactive technetium-99m and trioxide technetium containing technetium-99. In the case of using radioactive technetium-99m for medical service, it is not preferable that a synthesized product contains other radioactive substances. According to the method of the present embodiment, pertechnetate ions which contain radioactive technetium-99m but hardly contain other radioactive substances can be obtained.

For example, ruthenium trioxide (RuO₃) may be used as a ruthenium sample. In order to obtain solution containing high-purity technetium-99m from the irradiated sample, the following procedures are performed, for example. That is, the irradiated sample is put into a decompression treatment container, and is heated in a temperature range of 310° C. to 320° C. in the reduced pressure to obtain a sublimate. The pressure reduction may generally be in the range of 10 pascal to 100 pascal. The obtained sublimate is generally technetium oxide (Tc₂O₇) which contains 0.01% or less ruthenium oxide. This procedure uses the fact that technetium oxide (Tc₂O₇) gas containing technetium-99m is generated at the temperature of about 310° C. (in normal pressure), whereas trioxide ruthenium gas is generated at the temperature of about 400° C. (in normal pressure). Next, high-concentration sodium hydroxide solution is added to the sublimate, and after the sublimate is completely dissolved, hydrochloric acid solution is added to adjust pH in the range of 4 to 8. The obtained solution contains pertechnetate ions (TcO₄⁻). The molarity of sodium hydroxide may be about 4 M to 8 M. Next, the solution containing pertechnetate ions (TcO₄⁻) is passed through a column whose upper layer is filled with an adsorbent and whose lower layer is filled with ion exchange resin, and the solution which has passed the column is sampled. The adsorbent is to adsorb and remove [⁹⁹TcO₄⁻] ions contained in the solution containing pertechnetate ions (TcO₄⁻), and activated alumina and/or activated carbon are typically used. Since [^{99m}TcO₄⁻] ions equal in amount to [⁹⁹TcO₄⁻] ions are also adsorbed and removed in this procedure, the content of [⁹⁹TcO₄⁻] ions which are contained in the solution containing the pertechnetate ions (TcO₄⁻) is measured in advance by a gamma ray spectrometer and the like, so that a fill volume of the adsorbent corresponding to the amount of [⁹⁹TcO₄⁻] ions to be removed can properly be determined. The ion exchange resin is to remove the types of metal ions which are difficult to adsorb and remove by the adsorbent, and polystyrene-based ion exchange resin is generally used. The above procedures provide pertechnetate solution containing ^{99m}Tc whose radioactivity accounts for 99.985% or more of the total radioactivity.

(Others)

The muon generating device in the radioactive technetium-99m-containing substance synthesizing apparatus 100 is not limited to the above-described examples, and may be embodied by other devices that generate muons.

(Function and Effect of Embodiment)

The radioactive technetium-99m-containing substance synthesizing apparatus 100 generates muons, and irradiates the ruthenium sample as a target with the generated muons. When the ruthenium sample is irradiated with the muons, the ruthenium sample turns into a substance containing radioactive technetium-99m (a radioactive technetium-99m-containing substance) by the nuclear reaction between ruthenium in the ruthenium sample and the muons.

The synthesizing rate of radioactive technetium-99m from natural ruthenium per muon is as high as 15% as compared with the case of the nuclear reaction with use of a neutron and/or a proton. Moreover, the entire synthesizing efficiency can be enhanced by enhancing the efficiency in creation of muons. The synthesizing rate of radioactive technetium-99m from ruthenium with mass number 100 is 51% per muon. Therefore, the entire synthesizing efficiency is enhanced by using the ruthenium sample containing a large amount of ruthenium with mass number 100. More specifically, more radioactive technetium-99m can be obtained by using the ruthenium sample containing a large amount of ruthenium with mass number 100.

When a medium-size superconducting proton cyclotron having energy of 500 MeV, current of 300 μA, and 8T magnetic fields is used as a proton accelerator, radioactive technetium-99m is synthesized from the ruthenium sample containing natural ruthenium at the rate of 3.3×10¹⁰ per second. Radioactive technetium-99m is synthesized from the ruthenium sample containing only ruthenium 100 as ruthenium at the rate of 1.1×10¹¹ per second.

According to the method of the present embodiment, it becomes possible to obtain a radioactive technetium-99m-containing substance which hardly contains radioactive elements other than radioactive technetium-99m.

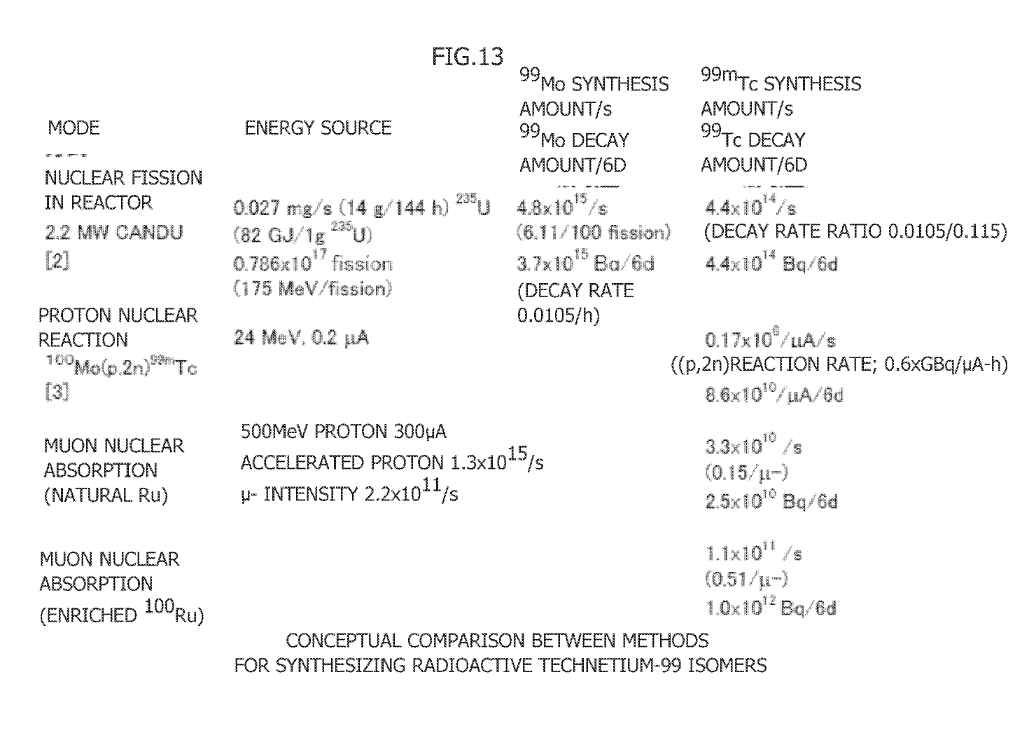

FIG. 13 illustrates the amount and characteristics of radioactive technetium-99m synthesized by a reactor, a low-energy proton accelerator, and an intermediate-energy proton accelerator. According to the method of the present embodiment, using the proton accelerator having energy of 500 MeV, current of 300 μA, and 8 T magnetic fields can produce radioactive technetium-99m with high efficiency comparable with the efficiency in the reactor method.

The radioactive technetium-99m-containing substance synthesizing apparatus in the present embodiment has a muon generation efficiency of 10⁻⁴ μ⁻/proton, and therefore further improvement can be expected. Therefore, improvement in the synthesis efficiency of the radioactive technetium-99m, which depends on the muon generation efficiency, can also be expected.

Radioactive technetium-99m is substantially the only radioactive substance generated by the nuclear reaction between ruthenium and muons. Therefore, there are high degree of freedom in chemical state and physical state of the materials to be selected as the ruthenium sample. More specifically, when the nuclear reaction between ruthenium and muons is induced by using, for example, metal ruthenium or ruthenium compounds, such as ruthenium oxide, ruthenium nitrate, and ruthenium sulfate, as a ruthenium sample, it becomes possible to obtain radioactive technetium-99m which can be used for medical service.

By using a plurality of ruthenium thin plates with a thickness of 0.4 cm or less, 140-keV gamma rays generated from the technetium-99m, which is contained in the radioactive technetium-99m-containing ruthenium sample, can be detected from the outside of the ruthenium sample.

According to the method of the present embodiment, the radioactive technetium-99m used for scintigram of every part of the body, including the bones, the kidney, the lungs, the thyroid glands, and the liver, can be synthesized also by low-energy proton accelerators installed in hospitals and the like.

The radioactive technetium-99m-containing substance synthesized by the method of the present embodiment does not generate radiations which hinder medical application. This highly facilitates synthesizing operation of radioactive technetium-99m.

Moreover, according to the method of the present embodiment, reactors and/or enriched uranium 235 are not used, so that long-lived radioactive wastes produced typically by uranium nuclear fission are not synthesized. Even when high-intensity low-energy proton accelerators are used, the problem of residual radioactivity in the sample or around the sample does not occur.

### REFERENCE SIGNS LIST

100 Technetium-99m-containing substance synthesizing apparatus

110 Muon generating device

112 Proton accelerator

114 Pion/muon synthesis target holding unit

116 Muon synthesizing beam optical system unit

120 Ruthenium sample holding unit

152 Normal conducting magnet coil

154 Superconducting magnet coil

156 Radiation shield

158 Magnetic shield

1. A method for synthesizing a radioactive technetium-99m-containing substance, comprising the steps of:
generating negative muons; and
irradiating a ruthenium sample with the negative muons.

2. The method for synthesizing a radioactive technetium-99m-containing substance according to claim 1, wherein
the ruthenium sample contains at least one of metal ruthenium and ruthenium compounds.

3. The method for synthesizing a radioactive technetium-99m-containing substance according to claim 1, wherein
the ruthenium sample is a laminate of a plurality of ruthenium thin plates having a thickness of 4 mm or less.

4. A radioactive technetium-99m-containing substance synthesizing apparatus, comprising:
a muon generating device that generates negative muons; and
a supporting device of a ruthenium sample to be irradiated with the negative muons generated by the muon device.

5. The radioactive technetium-99m-containing substance synthesizing apparatus according to claim 4, wherein
the ruthenium sample contains at least one of metal ruthenium and ruthenium compounds.

6. The radioactive technetium-99m-containing substance synthesizing apparatus according to claim 4, wherein
the ruthenium sample is a laminate of a plurality of ruthenium thin plates having a thickness of 4 mm or less.

7. The radioactive technetium-99m-containing substance synthesizing apparatus according to claim 4, wherein
the muon generating device includes a muon synthesizing beam optical system unit having a plurality of superconducting coils and an overall length of 6 m or more.

8. A radioactive technetium-99m-containing substance synthesized by the method for synthesizing a radioactive technetium-99m-containing substance according to claim 1.

9. The radioactive technetium-99m-containing substance according to claim 8, the substance comprising ruthenium oxide, wherein a total content of the ruthenium oxide is greater than 0.01% and less than or equal to 0,1%.

10. The radioactive technetium-99m-containing substance according to claim 8, the substance comprising ruthenium oxide, wherein a total content of the ruthenium oxide is equal to 0.01% or less.

11. The radioactive technetium-99m-containing substance according to claim 8, the substance being contained in pertechnetate solution, wherein a ratio of radioactivity of ^{99m}Tc to the total radioactivity of the pertechnetate solution is equal to 99,985% or greater, and a total content of ruthenium ion contained in the pertechnetate solution is greater than 0.01% and less than or equal to 0.1%.

12. The radioactive technetium-99m-containing substance according to claim 8, the substance being contained in pertechnetate solution, wherein a ratio of radioactivity of ^{99m}Tc to the total radioactivity of the pertechnetate solution is equal to 99.985% or greater; and a total content of ruthenium ion contained in the pertechnetate solution is equal to 0.01% or less.
